(19) United States
(12) Patent Application Publication
(10) Pub. No.: US 2013/0120481 A1
(43) Pub. Date: May 16, 2013

(54) IMAGE DISPLAY APPARATUS, DRIVER APPARATUS, AND BACKLIGHT UNIT

(71) Applicants: Takayuki Murai, Osaka-shi (JP); Kohji Fujiwara, Osaka-shi (JP); Toshiyuki Gotoh, Osaka-shi (JP)

(72) Inventors: Takayuki Murai, Osaka-shi (JP); Kohji Fujiwara, Osaka-shi (JP); Toshiyuki Gotoh, Osaka-shi (JP)

(73) Assignee: Sharp Kabushiki Kaisha, Osaka-shi Osaka (JP)

(21) Appl. No.: 13/812,146

(22) PCT Filed: Apr. 20, 2011
(86) PCT No.: PCT/JP2011/059676

§ 371 Date: Jan. 25, 2013

(30) Foreign Application Priority Data
Jul. 28, 2010 (JP) 2010-169008

(51) Int. Cl. G09G 3/34; G09G 5/10

(52) U.S. Cl. CPC G09G 3/3406; G09G 5/10
USPC 345/690; 345/102

(57) ABSTRACT

An image display apparatus comprising: a driver apparatus; and a total of N device groups of a first group to an N-th group (2≦N) each of which includes one or a plurality of light emitting devices, the image display apparatus uses the driver apparatus to make each of the device groups emit light preventing light emission capable periods from overlapping one another and displays an image by using the obtained light as backlight; wherein the driver apparatus includes: a power output circuit that outputs light emission power used for the light emission of the light emitting device; and a switch mechanism that switches, in accordance with arrival of the light emission capable period of a device group K (1≦K≦N), an output destination of the light emission power output from the power output circuit to the device group K.

### TECHNICAL FIELD

The present invention relates to an image display apparatus that displays an image by using light emitted from a light emitting device as backlight, a driver apparatus that makes the light emitting device emit light, and a backlight unit that includes the driver apparatus.

### BACKGROUND ART

Conventionally, various image display apparatuses such as a television broadcast receiver and the like are widely used. Besides, as an image display apparatus, for example, like a liquid crystal display apparatus that employs a field sequential system, an apparatus is proposed, in which a plurality of light emitting devices, that is, light sources of backlight, are time-divided, made to emit light such that periods (light emission capable periods) for allowing light emission do not overlap one another, whereby an image is displayed.

The liquid crystal display apparatus that uses the field sequential system is provided with, for example, a backlight unit which uses respective color LEDs of R, G, and B (red, green and blue) as light sources, and turns on the respective color LEDs in time division in one frame to display field images of the respective colors. The image of each frame is switched at a high speed, accordingly, for a viewer, it looks like these images overlap each other and are correctly displayed.

The field sequential system does not need a color filter and the like, accordingly, there are advantages that the production cost is reduced and a sufficient brightness is easily secured and the like. Meanwhile, the field sequential system itself is disclosed in a patent document 2, for example, and is already known.

Here, as an example of the backlight unit compatible with the field sequential system, an apparatus which performs PWM control of the light emission of the respective color LEDs is briefly described with reference to FIG. 9. As shown in FIG. 9, the backlight unit includes respective color LEDs 101, an LED driver 103 that drives the LEDs and the like.

The LED driver 103 has a plurality of control channels (in FIG. 9, 1 to 6 chs are shown) to each of which one or a plurality of the LEDs (device group described later) are connected. Besides, the LED driver 103 has a PWM circuit 104 (a form of a power output circuit), which outputs (outputs power Wout during an on-duty) light emission power adjusted in accordance with the PWM control, for each control channel.

Besides, the respective color LEDs 101 are disposed on an LED mount board 102 (board disposed on a rear side of a liquid crystal panel). Meanwhile, in FIG. 9, the LEDs 101 shown by “R”, “G”, and “B” indicate that the light emission colors are red (R), green (G), and blue (B), respectively. A plurality of the respective color LEDs 101 are prepared and disposed at suitable positions such that the light reaches throughout the liquid crystal panel with no unbalance.

Besides, the LEDs 101 connected to the same control channel (i.e., the same light emission control is performed) are clustered to form a plurality of device groups. More specifically, as shown in FIG. 9, each of the red LEDs 101 forms a group 1R, a group 2R, . . . , each of the green LEDs 101 forms a group 1G, a group 2G, . . . , and each of the blue LEDs 101 forms a group 1B, a group 2B, . . . . Each device group is connected to one of the control channels of the LED driver 103.

The backlight unit having the structure shown in FIG. 9 operates as follows. The backlight unit receives a driver control signal from a previous stage that performs control to make the backlight be synchronized with an image display timing. The driver control signal indicates a light emission capable period (which corresponds to a field period) of each control channel and a duty ratio of the PWM control. Meanwhile, it is also conceivable that the light emission color of a device group connected to each control channel is predetermined, and the driver control signal indicates a light emission capable period and a duty ratio of each light emission color.

In accordance with the driver control signal, the LED driver 103 makes each PWM circuit 104 output light emission power. Meanwhile, each PWM circuit 104 outputs the light emission power, which is adjusted in accordance with the duty ratio corresponding to the circuit itself, to the connected device group during the light emission capable period that corresponds to the circuit itself.

A timing chart shown in FIG. 10 indicates a timing of the output (power output) of the light emission power from each PWM circuit 104. Meanwhile, a white arrow shown in FIG. 10 (likewise, FIG. 3, FIG. 6 and FIG. 8 described later) indicates to which device group the light emission power is output for reference.

As shown in FIG. 10, a period (frame period) corresponding to one frame is divided substantially equally into periods (field periods) that correspond to the respective fields of R, G, and B. In an image display method using the field sequential system, each color field period corresponds to a period (in the liquid crystal panel, the light transmittance degree is controlled to be a state that corresponds to the color.) during which the color light should be output by using the backlight.

Accordingly, during the red field period, the PWM circuit 104 (PWM circuits A, D, . . . ) corresponding to the red device group outputs the light emission power; during the green field period, the PWM circuit 104 (PWM circuits B, E, . . . ) corresponding to the green device group outputs the light emission power; and during the blue field period, the PWM circuit 104 (PWM circuits C, F, . . . ) corresponding to the blue device group outputs the light emission power.

The backlight unit shown in FIG. 9 operates in this way to be compatible with the display method that uses the field sequential system.

### CITATION LIST

### Patent Literature

PLT1: JP-A-H9-297561
PLT1: JP-A-2003-271112
PLT1: JP-A-2010-122648

### SUMMARY OF INVENTION

### Technical Problem

Meanwhile, in various electric apparatuses, to achieve reduction of the production cost, size reduction of the product and the like, reduction of constituent components (circuit components and the like) are an important issue.

Here, looking at the number of PWM circuits 104 in the backlight unit that is shown in FIG. 9, the PWM circuit 104 is disposed to correspond to all the control channels of the LED driver 103. According to this, the LED driver 103 is able to set substantially freely the output timing of the light emission power and the like for each control channel and excellent in versatility.

However, as described above, in a case where the LED driver is applied to a liquid crystal display apparatus that use the field sequential system, as shown in FIG. 10, there is a likelihood that each PWM circuit 104 could output the light emission power during the corresponding field period (light emission capable period) only, and during a period other than the filed period, the PWM circuit goes to a standby state (state where there is no likelihood that the light emission power is output). As described above, in light of the situation where the standby state occurs in each PWM circuit, for example, it is desired to reduce the number of total PWM circuits by making one PWM circuit correspond to a plurality of the control channels.

Especially, in a case where it is decided beforehand that the LED driver is applied to the liquid crystal display apparatus that uses the field sequential system (e.g., a case where it is a component dedicated to the image display apparatus that uses the system), the versatility does not become very important. Because of this, in many cases, the reduction of the number of PWM circuits is focused on even if the versatility is lowered.

Meanwhile, this situation can also apply to an image display apparatus that employs scanning backlight. The scanning backlight is backlight that is used to make a light emitting device emit light during a predetermined period only for one line or each of a plurality of lines (a group of light emitting devices disposed to form a line in a horizontal direction) successively from top in accordance with the control of a liquid crystal panel, for example. According to the scanning backlight, the turning-on timing of each lone is suitably set considering a response speed and the like of the liquid crystal, whereby an image display apparatus excellent in moving image performance is achievable. Besides, when 3D display is performed, it is possible to alleviate crosstalk as low as possible.

Meanwhile, the scanning backlight itself is disclosed in a patent document 3, for example, and already known. If it is assumed that each control channel corresponds to each line, the period during which each PWM circuit can output the light emission power is limited, and the PWM circuit goes to the standby state during another period.

The situation where the standby state occurs as described above can apply to various image display apparatuses that drive a plurality of light emitting devices defining the light source of the backlight in time division. In light of the above problems, it is an object of the present invention to provide an image display apparatus that drives a plurality of light emitting devices defining the light source of the backlight in time division and is able to more reduce the number of constituent components. Besides, it is another object of the present invention to provide a driver apparatus and a backlight unit that are suitable as components of the image display apparatus.

### Solution to Problem

To achieve the above objects, an image display apparatus according to the present invention has a structure that includes: a driver apparatus; and a total of N device groups of a first group to an N-th group (2≦N) each of which includes one or a plurality of light emitting devices, the image display apparatus uses the driver apparatus to make each of the device groups emit light preventing light emission capable periods from overlapping one another and displays an image by using the obtained light as backlight; wherein the driver apparatus includes: a power output circuit that outputs light emission power used for the light emission of the light emitting device; and a switch mechanism that switches, in accordance with arrival of the light emission capable period of a device group K (1≦K≦N), an output destination of the light emission power output from the power output circuit to the device group K.

According to this structure, it is possible to make the output destination of the light emission power output from the same power output circuit correspond to each of the plurality of device groups without discouraging the light emission of the light emitting device. Because of this, for example, compared with an apparatus which is provided with the power output circuit for each device group, it becomes possible to reduce the number of power output circuits.

Meanwhile, the “light emission capable period” refers to a period (a period when the light emission is not actually performed may be present during the light emission capable period) that allows the light emitting device to emit light for control, however, is not limited to this form. As an example, a red field period in a display method using the field sequential system can become the light emission capable period of a red light emitting device.

Besides, as the above structure, more specifically, a structure may be employed, in which the power output circuit performs the PWM control at a set duty ratio to adjust the light emission power.

Besides, in the above structure, a structure may be employed, in which the power output circuit sets the duty ratio for each of the device groups, and performs the PWM control at the duty ratio set for the device group K during the light emission capable period of the device group K. According to this structure, it becomes possible to adjust light emission brightness for each device group.

Besides, as the above structure, more specifically, a structure may be employed, in which the device groups are disposed to be different from one another in light emission color; and the image is displayed by using the field sequential system during the light emission capable period of each of the device groups in each field.

Besides, as the above structure, more specifically, a structure may be employed, in which each of the device groups is disposed for each cluster of the light emitting devices that are disposed to form a line in a predetermined direction; and each of the device groups successively emits light to make the light emitting device function as the scanning backlight.

Besides, as the above structure, more specifically, a structure may be employed, in which the light emitting device is an LED. Besides, a liquid crystal display apparatus may be employed, which includes a liquid crystal panel that has a plurality of pixels and adjusts a transmittance degree of the backlight for each of the pixels to display the image.

Besides, a driver apparatus according to the present invention is a driver apparatus that includes a total of N control channels of 1ch to Nch (2≦N) to which the light emitting device is connected and outputs the light emission power used for the light emission of the light emitting device, wherein a structure is employed, in which the driver apparatus receives input of information about a light emission capable period of each of the control channels, and includes: a power output circuit that outputs the light emission power; and a switch mechanism that switches, in accordance with arrival of the light emission capable period of a control channel Kch (1≦K≦N), an output destination of the light emission power output from the power output circuit to the light emitting device connected to the control channel Kch.

According to this structure, it becomes possible to make the output destination of the light emission power output from the same power output circuit correspond to each of the plurality of control channels without discouraging the light emission of the light emitting device. Because of this, for example, compared with an apparatus which is provided with the power output circuit for each control channel, it becomes possible to reduce the number of power output circuits.

Besides, as the above structure, more specifically, a structure may be employed, in which the power output circuit performs the PWM control at the set duty ratio to adjust the light emission power.

Besides, in the above structure, a structure may be employed, in which the power output circuit sets the duty ratio for each of the control channels, and performs the PWM control at the duty ratio set for the control channel Kch during the light emission capable period of the control channel Kch. According to this structure, it becomes possible to adjust the light emission illuminance of the connected light emitting device for each control channel.

Besides, as the above structure, more specifically, an LED drier may be employed, which outputs the light emission power to the LED disposed as the light emitting device.

A backlight unit according to the present invention has a structure which includes: the driver apparatus having the above structure; and a light emitting device connected to each of the control channels, wherein light emitted from the light emitting device is used as backlight for image display. Besides, an image display apparatus according to another embodiment of the present invention has a structure which includes the backlight unit having the above structure and uses the backlight emitted from the backlight unit to display the image. According to these structures, it is possible to enjoy advantages of the driver apparatus according to the present invention.

### Advantageous Effects of Invention

As described above, in the image display apparatus according to the present invention, it becomes possible to make the output destination of the light emission power output from the same power output circuit correspond to each of the plurality of device groups without discouraging the light emission of the light emitting device. Because of this, for example, compared with an apparatus which is provided with the power output circuit for each device group, it becomes possible to reduce the number of power output circuits.

Besides, in the driver apparatus according to the present invention, it becomes possible to make the output destination of the light emission power output from the same power output circuit correspond to each of the plurality of control channels without discouraging the light emission of the light emitting device. Because of this, for example, compared with an apparatus which is provided with the power output circuit for each control channel, it becomes possible to reduce the number of power output circuits.

Besides, in the backlight unit according to the present invention, it is possible to enjoy the advantages of the driver apparatus according to the present invention. Meanwhile, the driver apparatus and the backlight unit are suitable as components for the image display apparatus according to the present invention.

### BRIEF DESCRIPTION OF DRAWINGS

FIG. 1 is a structural view of a television broadcast receiver according to an embodiment of the present invention.

FIG. 2 is a structural view of a backlight unit according to a first embodiment of the present invention.

FIG. 3 is a timing chart of output power from a PWM circuit according to the first embodiment of the present invention.

FIG. 4 is a structural view of an LED driver according to an embodiment of the present invention.

FIG. 5 is a structural view of a backlight unit according to a second embodiment of the present invention.

FIG. 6 is a timing chart of output power from a PWM circuit according to the second embodiment of the present invention.

FIG. 7 is a structural view of a backlight unit according to a third embodiment of the present invention.

FIG. 8 is a timing chart of output power from a PWM circuit according to the third embodiment of the present invention.

FIG. 9 is a structural view of a backlight unit in an example of a conventional image display apparatus.

FIG. 10 is a timing chart of output power from a PWM circuit in an example of a conventional image display apparatus.

### DESCRIPTION OF EMBODIMENTS

Embodiments of the present invention are described hereinafter with reference to each of a first embodiment to a third embodiment.

### 1. First Embodiment

First, the first embodiment of the present invention is described hereinafter with reference to a television broadcast receiver (a form of an image display apparatus) which employs a display method using the field sequential system.

[Structure and the Like of Television Broadcast Receiver]

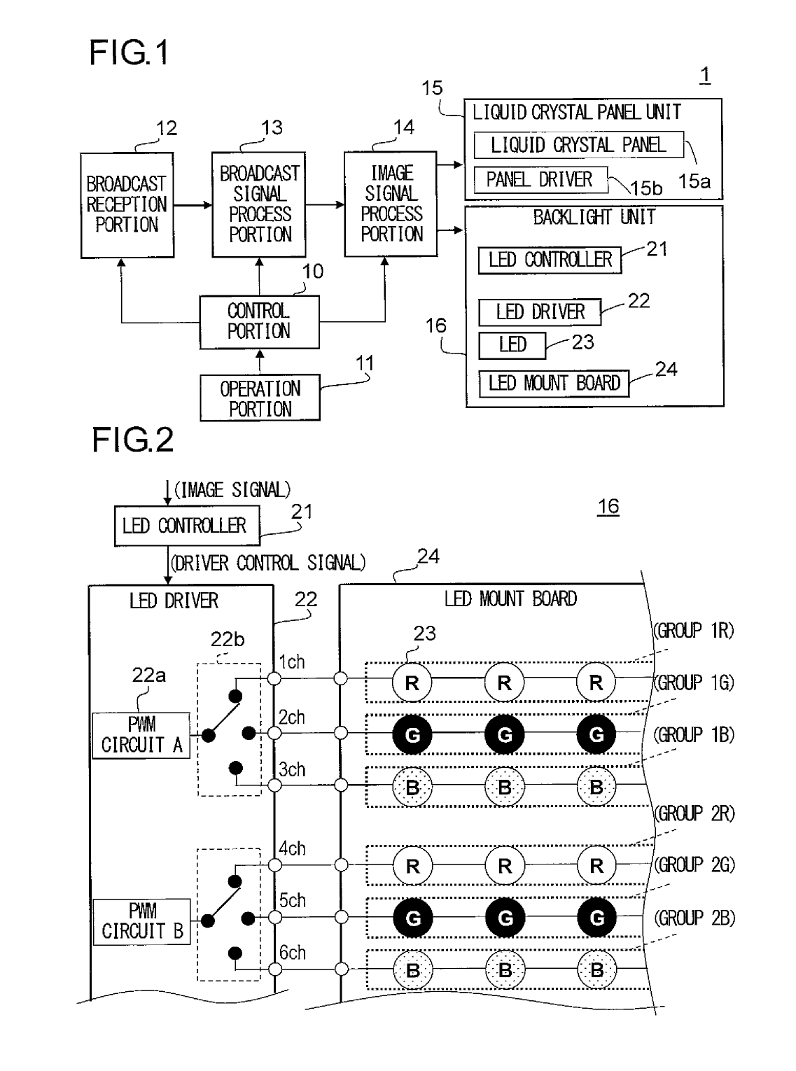

FIG. 1 is a schematic structural view of the television broadcast receiver. As shown in this figure, the television broadcast receiver 1 includes: a control portion 10; an operation portion 11; a broadcast reception portion 12; a broadcast signal process portion 13; an image signal process portion 14; a liquid crystal panel unit 15; a backlight unit 16 and the like.

The control portion 10 controls each portion of the television broadcast receiver 1 to make them execute various processes necessary to demonstrate functions (function to display a television broadcast image and the like) of the television broadcast receiver 1. Besides, the operation portion 11 includes a switch that is operated by a user and transmits the operation content to the control portion 10. According to this, it is possible to reflect the user's intention into various operations of the television broadcast receiver 1.

The broadcast reception portion 12 has an antenna, a tuner apparatus and the like, and successively receives broadcast signals that are transmitted from a television broadcast station. A broadcast channel to be selected is controlled by the control portion 10. The received broadcast signal is output to the broadcast signal process portion 13.

The broadcast signal process portion 13 extracts an image signal (signal that indicates a moving image composed of a plurality of frames) and a voice signal from the broadcast signal, outputs the image signal to the mage signal process portion 14 and outputs the voice signal to a not-shown speaker apparatus (apparatus that generates a voice based on the voice signal).

The image signal process portion 14 applies necessary processes (e.g., a decompression process, a color tone correction process) to the image signal received from the previous stage and generates an image signal compatible with the display method using the field sequential system. This image signal is composed of a clock signal and a synchronization signal for indicating each frame period and each field period, a brightness signal for indicating a brightness of each pixel for each field (also possible for each of R, G, and B colors) and the like.

Meanwhile, the order of fields in each frame (i.e., the field period arrives in the order of red, green, and blue.) is predetermined. Because of this, according to this image signal, it is indicated to which color field the current time point belongs. The image signal generated in this way is output to the liquid crystal panel unit 15 and the backlight unit 16.

The liquid crystal panel unit 15 includes a liquid crystal panel 15a, a panel driver 15b and the like. The liquid crystal panel 15a is composed of boards that are disposed to oppose each other via a liquid crystal layer; a pixel electrode that is disposed to correspond to each pixel; a TFT [Thin Film Transistor] that functions as a switching device and the like.

In the liquid crystal panel 15a, voltages between respective pixel electrodes are adjusted, whereby a transmittance degree of the backlight for each pixel is adjusted and an image is displayed as a whole. Meanwhile, the liquid crystal panel 15a is compatible with the display method that uses the field sequential system, accordingly, a color filter for changing the backlight color is not disposed.

In accordance with the image signal received from the image signal process portion 14, the panel driver 15b performs the adjustment (i.e., an update of the display content) of the voltage of each pixel electrode in the liquid crystal panel 15a. More specifically, every time the field is switched in each frame, the panel driver 15b performs the adjustment based on a brightness signal corresponding to a new field (to display the mage for each frame).

The backlight unit 16 includes: an LED controller 21; an LED driver 22; an LED 23; an LED mount board 24 and the like. Meanwhile, a more detailed structure of the backlight unit 16 is as shown in FIG. 2.

The LED driver 22 has a plurality of control channels (in FIG. 2, 1 to 6 chs. are shown) to each of which one or a plurality of the LEDs 23 (device groups described later) are connected. Besides, the LED driver 22 is provided with a PWM circuit 22a that successively outputs power adjusted by PWM control as light emission power (power used for light emission of the LED 23). Meanwhile, the PWM circuit 22a outputs power Wout in accordance with an on-duty. Meanwhile, a duty ratio of the PWM control is set in an updatable manner for each PWM circuit 22a.

Besides, the LED driver 22 is also provided with a switch mechanism 22b that switches an output destination of the light emission power output from each PWM circuit 22a. Meanwhile, as shown in FIG. 2, one PWM circuit 22a corresponds to three control channels. For example, the PWM circuit A corresponds to each of the three control channels 1ch to 3ch. And, it is possible to switch, by using the switch mechanism 22b, the output destination of the light emission power output from each PWM circuit 22a among the respective device groups connected to the three control channels.

Besides, the LED driver 22 receives an input of a driver control signal that indicates a light emission capable period of each control channel and a duty ratio of the PWM control, and operates in accordance with this driver control signal. More specifically, in accordance with the driver control signal, the LED driver 22 performs the update of the duty ratio set in each PWM circuit 22a and the switching (thanks to control of the switch mechanism 22b) of the output destination of the light emission power from each PWM circuit 22a.

For example, looking at the PWM circuit A, when the light emission capable period for the 1ch arrives, the set duty ratio is updated to a duty ratio corresponding to the 1ch, and the output destination of the light emission power is switched to the device group (group 1R) connected to the 1ch. Thereafter, when the light emission capable period for the 2ch arrives, the set duty ratio is updated to a duty ratio corresponding to the 2ch, and the output destination of the light emission power is switched to the device group (group 1G) connected to the 2ch. Further, thereafter, when the light emission capable period for the 3ch arrives, the set duty ratio is updated to a duty ratio corresponding to the 3ch, and the output destination of the light emission power is switched to the device group (group 1B) connected to the 3ch.

As a result of this, the device group (each LED 23 belonging to the device group) connected to one of the control channels emits light (shines) during the light emission capable period for the control channel in accordance with the duty ratio for the control channel. Meanwhile, during a period other than the light emission capable period, the device group is not supplied with the light emission power and goes to a turned-off state.

The LED 23 functions as a light source of the backlight and is disposed on the LED mount board 24 (board disposed on a rear side of the liquid crystal panel 15a). Meanwhile, in FIG. 2, it is indicated that the LEDs 23 shown by “R”, “G” and “B” emit the color light of red, green, and blue, respectively. A plurality of the LEDs 23 are disposed for each color and ranged at suitable positions such that the light reaches throughout the liquid crystal panel 15a with no unbalance.

Besides, the LEDs 23 connected to the same control channel (i.e., the same light emission control is applied) are clustered to form a plurality of the device groups. More specifically, as shown in FIG. 2, the red LEDs 23 form the respective device groups of a group 1R, a group 2R, . . . , the green LEDs 23 form the respective device groups of a group 1G, a group 2G, . . . , and the green LEDs 23 form the respective device groups of a group 1B, a group 2B, . . . . In each device group, the LEDs 23 are connected to one another by wiring.

Meanwhile, one PWM circuit 22a is responsible for the supply of the light emission power to one device group. Because of this, the number of LEDs 23 included in one device group and the like (load size) are limited not to exceed output performance of one PWM circuit 22a.

And, each device group is connected to one of the control channels of the LED driver 22. More specifically, the red device group, the green device group and the blue device group (i.e., the device groups having the colors different from one another) are connected to the three control channels corresponding to one PWM circuit 22a, respectively.

For example, looking at the PWM circuit A, the device group 1R (red) is connected to the 1 ch of the control channels corresponding to this circuit, the device group 1G (green) is connected to the 2ch, and the device group 1B (blue) is connected to the 3ch. Meanwhile, information about to which color each control channel corresponds (which color device group is connected) is registered in the LED controller 21.

Based on the image signal received from the image signal process portion 14, the LED controller 21 generates the above driver control signal and inputs the control signal into the LED driver 22. In other words, for example, based on an average value of brightnesses of the respective pixels of each field, the LED controller 21 calculates a target value of backlight illuminance of each field (of each of R, G, and B). And, the LED controller 21 generates the driver control signal such that the target value of each color or a related value becomes the duty ratio of the control channel that corresponds to the color and further each color field period becomes the light emission capable period of the control channel that corresponds to the color.

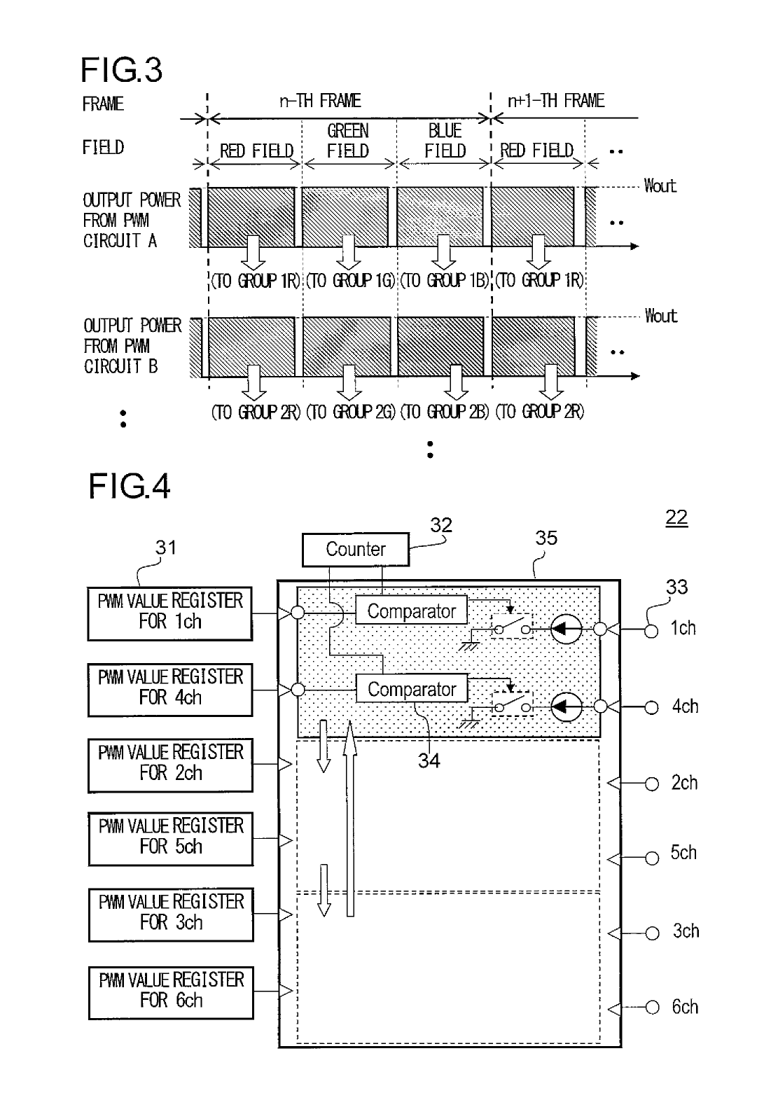

FIG. 3 is a timing chart of the light emission power (output power) output from each PWM circuit 22a. As shown in this figure, for example, the PWM circuit A outputs the light emission power to the corresponding red device group (group 1R) during the red field period; outputs the light emission power to the corresponding green device group (group 1G) during the green field period; and outputs the light emission power to the corresponding blue device group (group 1B) during the blue field period. This operation applies to the other PWM circuits 22a as well.

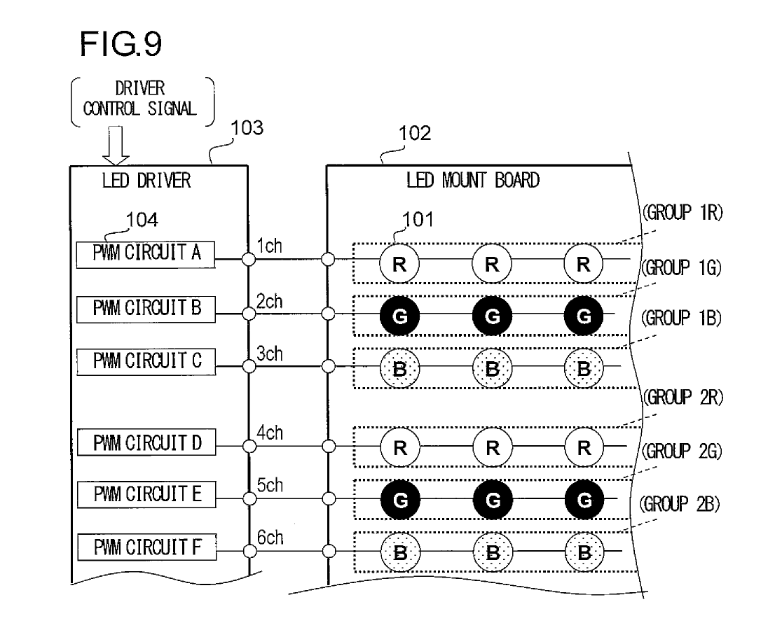

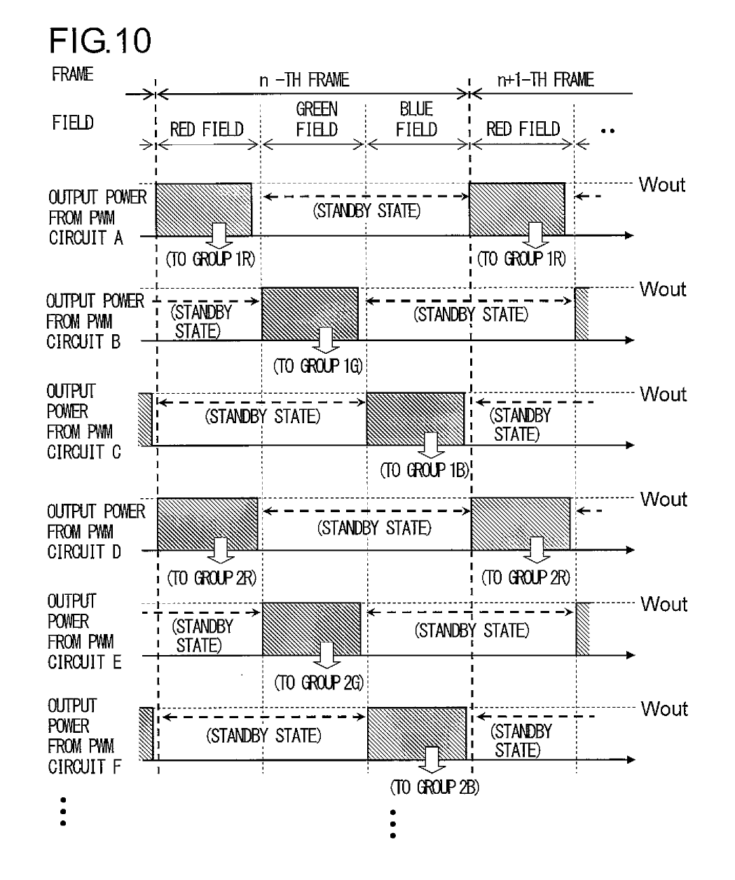

As described above, the LED driver 22 has only one PWM circuit that is used for the output of the light emission power to the three device groups (the corresponding colors are different from one another). Because of this, compared with the LED driver (see FIG. 9) in which it is assumed that the PWM circuit is disposed for each control channel (each device group), in the LED driver 22 according to the present embodiment, the number of PWM circuits is reduced to substantially one third.

Meanwhile, the field periods of the respective colors are periods that are obtained by time-dividing the frame period, accordingly, they do not overlap one another. Because of this, a situation, in which the light emission power is output to two or more device groups corresponding to one PWM circuit 22a at the same time, does not occur, and in the LED driver 22, occurrence of this situation does not cause a malfunction. It is also conceivable that by using this, the LED driver 22 reduces the number of PWM circuits 22a.

In the television broadcast receiver 1, each of the above operations is executed and each color field image (image corresponds to an constituent element of one frame) is displayed in time division on the liquid crystal panel 15a. Each of the field images is switched at a high speed, accordingly, for a viewer, these images look overlapping, and it looks like the images are displayed correctly.

[Detailed Structure of LED Driver]

The schematic structure of the LED driver 22 is as described above, and it is possible to employ various forms of kinds, disposition states and the like of a circuit that is used to achieve this structure. Here, a more detailed structure of the LED driver 22 is described hereinafter by using FIG. 4 as an example.

As shown in FIG. 4, the LED driver 22 includes: a PWM value register 31; a counter 32; an output terminal 33; a comparator 34; a switch mechanism 35 and the like. Meanwhile, as the control channel, six control channels of 1 to 6 chs are disposed. Besides, in the LED driver 22 of this form, the PWM value register 31, the counter 32, the comparator 34 and the like correspond to the PWM circuit 22a described above, and the switch mechanism 35 and the like correspond to the switch mechanism 22b described above.

A clock signal for allocating 4096 (12 bits) pulses to the light emission capable period of each control channel and a signal indicating the PWM value (one value of 0 to 4095, that is, a value for deciding the duty ratio as described later) of each control channel are input into the LED driver 22 as the driver signal. The signal indicating the PWM value is input by the beginning of the light emission capable period of the 1ch (and the 4 ch).

The PWM value register 31 is disposed for each control channel, and information of the PWM value corresponding to the control channel itself is written into. The written information of the PWM value is output to the comparator 34.

The counter 32 counts the number of pulses of the clock signal and outputs information of the currently counted value (count value) to the comparator 34. Meanwhile, the count value is reset every time a new light emission capable period of the control channel arrives. The output terminal 33 is disposed for each control channel and is connected to one LED or a plurality of the LEDs.

Two comparators 34 are disposed such that each of them corresponds to one control channel (in the state shown in FIG. 4, they correspond to the 1 ch and the 4 ch, respectively). The comparator 34 successively compares the input PWM value (of the corresponding control channel) and the count value with each other, and flows a predetermined amount of electric current to the LED connected to the output terminal 33 (of the corresponding control channel) during only a period when the PWM value is larger (the light emission power is output).

The switch mechanism 35 switches the control channel corresponding to each comparator 34 every time a new light emission capable period of the control channel arrives. Meanwhile, as shown in FIG. 4, each comparator 34 is switched by the switch mechanism 35 to one of a state where to correspond to the 1 ch and the 4 ch, a state where to correspond to the 2 ch and the 5 ch, and a state where to correspond to the 3 ch and the 6 ch.

The LED driver 22 having the structure described above operates as follows. At the time when the light emission capable period (which corresponds to the red field period and matches the light emission capable period of the 4 ch.) of the 1 ch arrives, the newest PWM value is written in each PWM value register 31, and each comparator 34 is in the state where to correspond to each of the 1 ch and the 4 ch.

In this state, each comparator 34 flows an electric current to the LED (the light emission power is supplied) in accordance with the comparison result of the PWM value and the count value. According to this, the PWM control is applied to the light emission of the LED connected to the 1 ch and the 4 ch. Meanwhile, the duty ratio of the PWM control is expressed by the PWM value/(3×4096) (however, when the light emission capable period of the 1 ch is 100%, the duty ratio becomes the PWM value/4096.).

And, when the counter 32 counts to 4095, the switch mechanism 35 switches the control channel corresponding to each comparator 34 to each of the 2 ch and the 5 ch. In other words, in response to the arrival of the light emission capable period of the 2 ch (which corresponds to the green field period and matches the light emission capable period of the 5 ch), the switching is performed.

In this state, each comparator 34 flows an electric current to the LED in accordance with the comparison result of the PWM value and the count value. According to this, the PWM control is achieved for the light emission of the LED connected to the 2 ch and the 5 ch.

And, further, when the counter 32 counts to 4095, the switch mechanism 35 switches the control channel corresponding to each comparator 34 to each of the 3 ch and the 6 ch. In other words, in response to the arrival of the light emission capable period of the 3 ch (which corresponds to the blue field period and matches the light emission capable period of the 6 ch), the switching is performed.

In this state, each comparator 34 flows an electric current to the LED in accordance with the comparison result of the PWM value and the count value. According to this, the PWM control is achieved for the light emission of the LEDs connected to the 3 ch and the 6 ch.

And, further, when the counter 32 counts to 4095, the switch mechanism 35 switches the control channel corresponding to each comparator 34 to each of the 1 ch and the 4 ch. Thereafter, the operation already described is executed repeatedly. As described above, the LED driver 22 is compatible with the display method that uses the field sequential system and is able to deal with the PWM control of the LED light emission in each field.

### 2. Second Embodiment

Next, a second embodiment of the present invention is described hereinafter with reference to a television broadcast receiver which employs the scanning backlight. Meanwhile, in the description of the present embodiment, portions different from the first embodiment are chiefly described, and there is a case where double description is skipped.

A whole structure of the television broadcast receiver is basically the same as the first embodiment. In other words, as shown in FIG. 1, the television broadcast receiver 1 according to the present embodiment includes: the control portion 10; the operation portion 11; the broadcast reception portion 12; the broadcast signal process portion 13; the image signal process portion 14; the liquid crystal panel unit 15; the backlight unit 16 and the like. Besides, the structures of the control portion 10, the operation portion 11, the broadcast reception portion 12 and the broadcast signal process portion 13 are common to each embodiment, accordingly, double description is skipped.

The image signal process portion 14 applies the necessary processes (e.g., the decompression process, the color tone correction process) to the image signal received from the previous stage and generates an image signal compatible with the scanning backlight. This image signal is composed of a clock signal, a synchronization signal that includes a horizontal synchronization signal and a vertical synchronization signal, a brightness signal for indicating a brightness of each pixel and the like. The generated image signal is output to the liquid crystal panel unit 15 and the backlight unit 16.

The liquid crystal panel unit 15 includes the liquid crystal panel 15a, the panel driver 15b and the like. The liquid crystal panel 15a is composed of the boards that are disposed to oppose each other via the liquid crystal layer; the pixel electrode that is disposed to correspond to each pixel; the TFT [Thin Film Transistor] that functions as the switching device, color filters of R, G, and B for changing the backlight color and the like. In the liquid crystal panel 15a, the voltages between the respective pixel electrodes are adjusted, whereby the transmittance degree of the backlight for each pixel is adjusted and an image is displayed as a whole.

In accordance with the image signal received from the image signal process portion 14, the panel driver 15b performs the adjustment (i.e., an update of the display content) of the voltage of each pixel electrode in the liquid crystal panel 15a. Meanwhile, the panel driver 15b performs the adjustment successively from the uppermost pixel (i.e., targets one lower line for the adjustment every time one line adjustment is ended.) in each frame.

The backlight unit 16 includes: the LED controller 21; the LED driver 22; the LED 23; the LED mount board 24 and the like. Meanwhile, a more detailed structure of the backlight unit 16 is as shown in FIG. 5.

The LED driver 22 has a plurality of control channels (1 to N chs) to each of which one or a plurality of the LEDs 23 (device groups described later) are connected. Besides, the LED driver 22 is provided with one PWM circuit 22a that successively outputs power adjusted by the PWM control as the light emission power. The PWM circuit 22a outputs the power Wout during an on-duty. Meanwhile, the duty ratio of the PWM control is set in an updatable manner.

Besides, the LED driver 22 is also provided with the switch mechanism 22b that switches an output destination of the light emission power output from the PWM circuit 22a. Meanwhile, as shown in FIG. 5, the PWM circuit 22a corresponds to all the control channels of the 1 to N chs. And, it is possible to switch, by using the switch mechanism 22b, the output destination of the light emission power output from the PWM circuit 22a among the device groups connected to the respective control channels.

Besides, the LED driver 22 receives an input of the driver control signal that indicates the light emission capable period of each control channel and the duty ratio of the PWM control, and operates in accordance with this driver control signal. More specifically, in accordance with the driver control signal, the LED driver 22 performs the update of the duty ratio set in the PWM circuit 22a and the switching (thanks to control of the switch mechanism 22b) of the output destination of the light emission power output from the PWM circuit 22a.

In other words, when the light emission power for the Kch (1≦K≦N) arrives, the set duty ratio is updated to a duty ratio corresponding to the Kch, and the output destination of the light emission power is switched to the device group (group K) connected to the Kch.

As a result of this, the device group (each LED 23 belonging to the device group) connected to one of the control channels emits light (shines) during the light emission capable period for the control channel in accordance with the duty ratio for the control channel. Meanwhile, during a period other than the light emission capable period, the device group is not supplied with the light emission power and goes to a turned-off state.

The LED 23 functions as a light source of the backlight and is disposed on the LED mount board 24 (board disposed on the rear side of the liquid crystal panel 15a). Besides, as the LED 23, a white LED which emits white color light is used. Meanwhile, besides the white LED, the LED 23 may be an LED unit which aggregates devices that emit the color light of R, G, and B (or, R, G, B, and W), respectively.

A plurality of the LEDs 23 are disposed and ranged at suitable positions such that the light reaches throughout the liquid crystal panel 15a with no unbalance. More specifically, the LEDs 23 are disposed at substantially equal intervals in a vertical direction and a horizontal direction (a substantially checkered shape). Meanwhile, hereinafter, there is a case where a group of the LEDs 23 disposed to form a line in the horizontal direction is called a “line” for the sake of description. Besides, there is a case where a line situated at a K-th position from top is called a “K-th line”.

On the LED mount board 24, the LEDs 23 are disposed to successively form the first line to the N-th line from top. And, the LED mount board 24 is disposed to overlie the rear side of the liquid crystal panel 15a, accordingly, it is conceivable that each line corresponds to each pixel overlapping the line (and a region near the line in the LED mount board 24). In other words, when one line is turned on, the backlight is chiefly supplied to each pixel that overlaps the line.

Besides, the LEDs 23 connected to the same control channel (i.e., the same light emission control is applied) are clustered to form a plurality of the device groups. More specifically, as shown in FIG. 5, the first line forms a group 1, the second line forms a group 2, . . . , and likewise, the K-th line forms a group K.

Meanwhile, the PWM circuit 22a is responsible for the supply of the light emission power to each device group. Because of this, the number of LEDs 23 included in one device group and the like (load size) are limited not to exceed at least the output performance of the PWM circuit 22a.

And, the device group K is connected to the control channel Kch. In other words, each of the LEDs 23 belonging to the K-th line is connected to the control channel Kch. Meanwhile, information about to which color each control channel corresponds is registered in the LED controller 21.

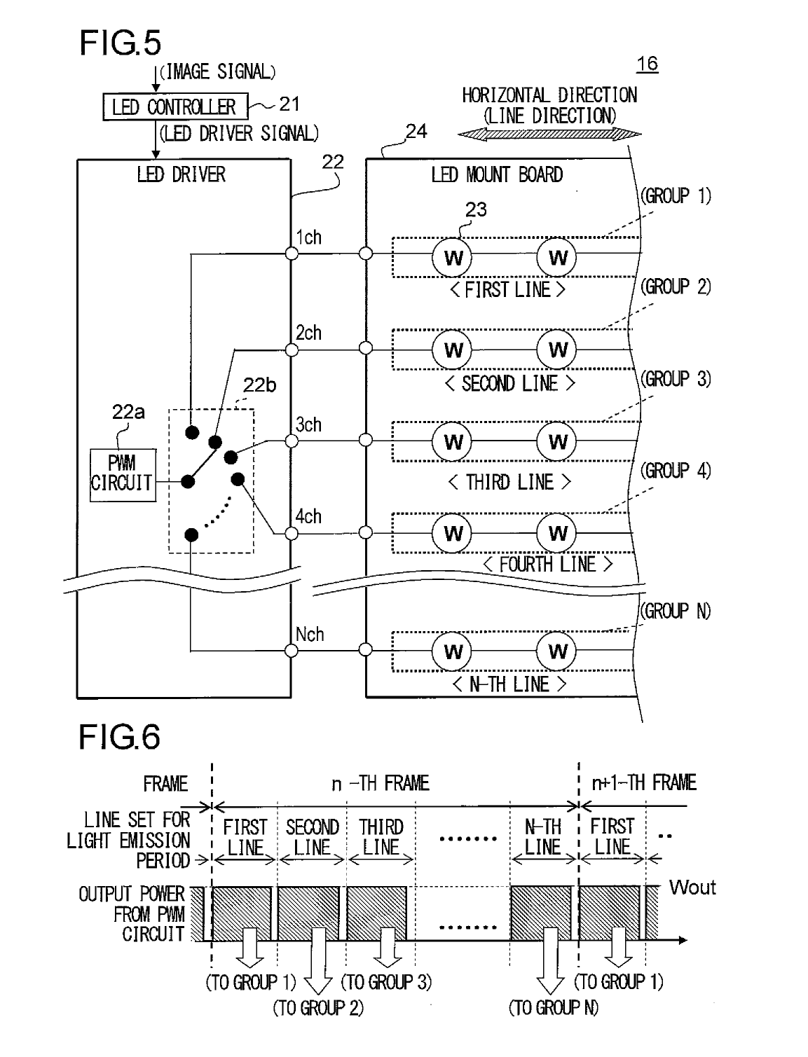

Based on the image signal received from the image signal process portion 14, the LED controller 21 generates the above driver control signal and inputs the control signal into the LED driver 22. In other words, for example, based on an average value of brightnesses corresponding to the respective pixels, the LED controller 21 calculates a target value of backlight illuminance of each line. Besides, the LED controller 21 recognizes a pixel adjustment period (period during which the display content is updated in the liquid crystal panel 15a) corresponding to each line as a light emission period of each line as shown on top of FIG. 6.

And, the LED controller 21 generates the driver control signal such that the target value of each line or the related value becomes the duty ratio of the control channel that corresponds the line and further the light emission period of each line becomes the light emission capable period of the control channel that corresponds to the line.

FIG. 6 is a timing chart of the light emission power (output power) output from the PWM circuit 22a. As shown in this figure, the PWM circuit 22a outputs the light emission power to the K-th line device group (group K) during the light emission period of the K-th line.

As described above, the LED driver 22 has only one PWM circuit that is used for the output of the light emission power to the N device groups (the line are different from one another). Because of this, compared with the LED driver in which it is assumed that the PWM circuit is disposed for each control channel (each device group), in the LED driver 22 according to the present embodiment, the number of PWM circuits is reduced to substantially 1/N.

Meanwhile, as long as the light emission periods of the respective lines are decided not to overlap one another (the light emission period of each line is divided into periods obtained by time-dividing the frame period), the light emission periods (light emission capable periods) of the respective lines do not overlap one another. Because of this, a situation, in which the light emission power is output at the same time, does not occur, and in the LED driver 22, occurrence of this situation does not cause a malfunction. It is also conceivable that by using this, the LED driver 22 reduces the number of PWM circuits 22a.

### 3. Third Embodiment

Next, a third embodiment of the present invention is described hereinafter with reference to a television broadcast receiver which likewise employs the scanning backlight. Meanwhile, in the description of the present embodiment, portions different from the second embodiment are chiefly described, and there is a case where double description is skipped.

A whole structure of the television broadcast receiver is basically the same as the first and second embodiments. In other words, as shown in FIG. 1, the television broadcast receiver 1 according to the present embodiment includes: the control portion 10; the operation portion 11; the broadcast reception portion 12; the broadcast signal process portion 13; the image signal process portion 14; the liquid crystal panel unit 15; the backlight unit 16 and the like. Besides, the structures of the control portion 10, the operation portion 11, the broadcast reception portion 12, the broadcast signal process portion 13, the image signal process portion 14, and the liquid crystal panel unit 15 are common to the second embodiment, accordingly, double description is skipped.

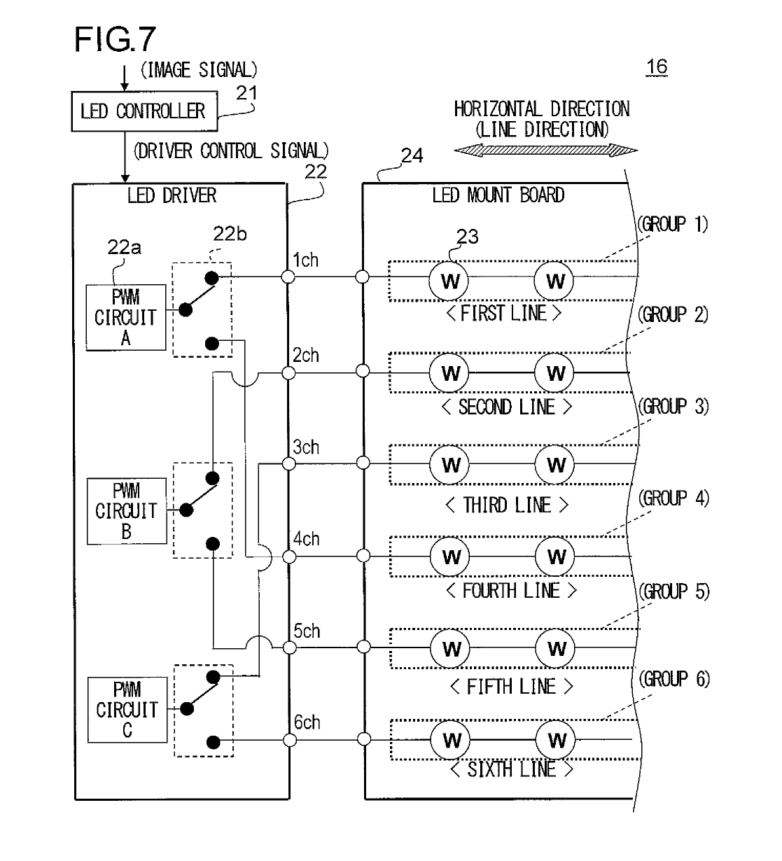

The backlight unit 16 includes: the LED controller 21; the LED driver 22; the LED 23; the LED mount board 24 and the like. Meanwhile, a more detailed structure of the backlight unit 16 is as shown in FIG. 7.

The LED driver 22 has a plurality of control channels (here, 1 to 6 ch) to each of which one or a plurality of the LEDs 23 (device groups described later) are connected. Besides, the LED driver 22 is provided with three PWM circuits 22a (PWM circuits A to C) that successively output the power adjusted by the PWM control as the light emission power. Each PWM circuit 22a outputs the power Wout during an on-duty. Meanwhile, the duty ratio of the PWM control is set for each PWM circuit 22a in an updatable manner.

Besides, the LED driver 22 is also provided with the switch mechanism 22b that switches the output destination of the light emission power output from each PWM circuit 22a. Meanwhile, as shown in FIG. 7, the PWM circuit A corresponds to the 1ch and the 4ch, the PWM circuit B corresponds to the 2ch and the 5ch, and the PWM circuit C corresponds to the 3ch and the 6ch. And, it is possible to switch, by using the switch mechanism 22b, the output destination of the light emission power output from each PWM circuit 22a among the device groups connected to the corresponding control channels, respectively.

Besides, the LED driver 22 receives the input of the driver control signal that indicates the light emission capable period of each control channel and the duty ratio of the PWM control, and operates in accordance with this driver control signal. More specifically, in accordance with the driver control signal, the LED driver 22 performs the update of the duty ratio set in each PWM circuit 22a and the switching (thanks to the control of the switch mechanism 22b) of the output destination of the light emission power output from each PWM circuit 22a.

For example, looking at the PWM circuit A, when the light emission capable period for the 1ch arrives, the set duty ratio is updated to a duty ratio corresponding to the 1ch, and the output destination of the light emission power is switched to the device group (group 1) connected to the 1ch. Thereafter, when the light emission capable period for the 4ch arrives, the set duty ratio is updated to a duty ratio corresponding to the 4ch, and the output destination of the light emission power is switched to the device group (group 4) connected to the 4ch.

As a result of this, the device group (each LED 23 belonging to the device group) connected to one of the control channels emits light (shines) during the light emission capable period for the control channel in accordance with the duty ratio for the control channel. Meanwhile, during a period other than the light emission capable period, the device group is not supplied with the light emission power and goes to a turned-off state.

The LED 23 functions as the light source of the backlight and is disposed on the LED mount board 24 (board disposed on the rear side of the liquid crystal panel 15a). Besides, as the LED 23, a white LED which emits white color light is used. Meanwhile, besides the white LED, the LED 23 may be an LED unit (which emits the white color light as a whole) which aggregates devices that emit the color light of R, G, and B (or, R, G, B, and W), respectively.

A plurality of the LEDs 23 are disposed and ranged at suitable positions such that the light reaches throughout the liquid crystal panel 15a with no unbalance. More specifically, the LEDs 23 are disposed at substantially equal intervals in the vertical direction and the horizontal direction (a substantially checkered shape), further, disposed to successively form a first line to a sixth line from top.

Besides, the LEDs 23 connected to the same control channel (i.e., the same light emission control is applied) are clustered to form a plurality of the device groups. More specifically, as shown in FIG. 7, the first line forms a group 1, the second line forms a group 2, . . . , and likewise, the K-th line forms a group K.

Meanwhile, the PWM circuit 22a is responsible for the supply of the light emission power to each device group. Because of this, the number of LEDs 23 included in one device group and the like (load size) are limited not to exceed at least the output performance of the PWM circuit 22a.

And, the device group K is connected to the control channel Kch. In other words, each of the LEDs 23 belonging to the K-th line is connected to the control channel Kch. Meanwhile, information about to which line each control channel corresponds is registered in the LED controller 21.

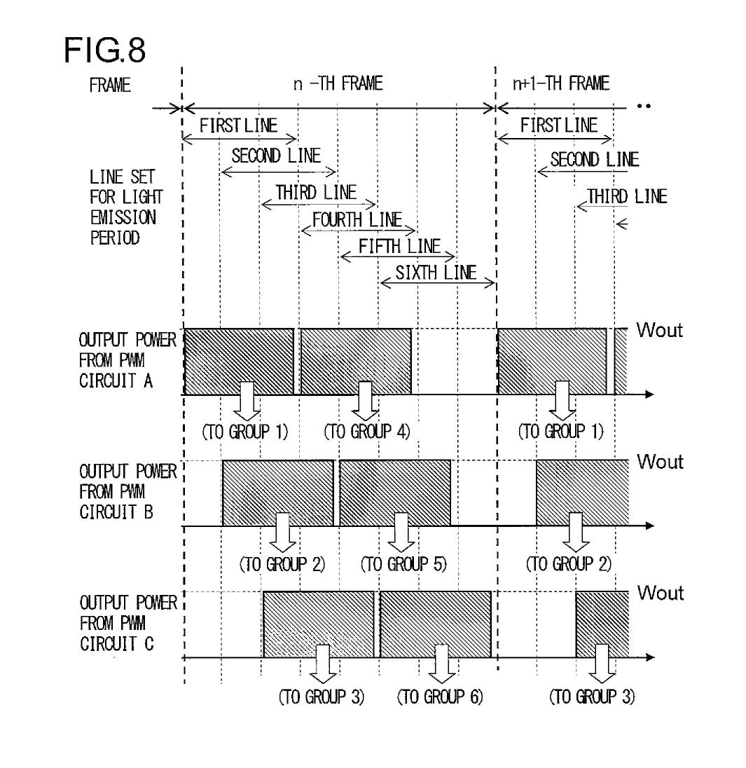

Based on the image signal received from the image signal process portion 14, the LED controller 21 generates the above driver control signal and inputs the control signal into the LED driver 22. In other words, for example, based on an average value of brightnesses corresponding to the respective pixels, the LED controller 21 calculates a target value of the backlight illuminance of each line. Besides, the LED controller 21 recognizes a predetermined period including the pixel adjustment period corresponding to each line as a light emission period of each line as shown on top of FIG. 8.

And, the LED controller 21 generates the driver control signal such that the target value of each line or the related value becomes the duty ratio of the control channel that corresponds the line and further the light emission period of each line becomes the light emission capable period of the control channel that corresponds to the line.

Meanwhile, in the second embodiment, only the pixel adjustment period corresponding to each line is used as the light emission period of each line. However, to more brighten the backlight, the LED controller in the present embodiment uses a period, which is obtained by adding an extension period to the pixel adjustment period corresponding to each line, as the light emission period of each line.

FIG. 8 is a timing chart of the light emission power (output power) output from each PWM circuit 22a. As shown in this figure, the PWM circuit A outputs the light emission power to the first-line device group (group 1) during the light emission period of the first line, and outputs the light emission power to the fourth-line device group (group 4) during the light emission period of the fourth line. Besides, the PWM circuit B outputs the light emission power to the second-line device group (group 2) during the light emission period of the second line, and outputs the light emission power to the fifth-line device group (group 5) during the light emission period of the fifth line. Besides, the PWM circuit C outputs the light emission power to the third-line device group (group 3) during the light emission period of the third line, and outputs the light emission power to the sixth-line device group (group 6) during the light emission period of the sixth line.

As described above, the LED driver 22 has only one PWM circuit that is used for the output of the light emission power to the two device groups (the 1ch and the 4ch, the 2ch and the 5ch, and the 3ch and the 6ch). Because of this, compared with the LED driver in which it is assumed that the PWM circuit is disposed for each control channel (each device group), in the LED driver 22 according to the present embodiment, the number of PWM circuits is reduced to substantially half.

Meanwhile, as long as the light emission periods of the respective lines are set as shown on top of FIG. 8, the light emission periods (light emission capable periods) of the first line and fourth line do not overlap each other, the light emission periods of the second line and fifth line do not overlap each other, and the light emission periods of the third line and sixth line do not overlap each other. Because of this, a situation, in which the light emission power is output to the first-line and fourth-line device groups at the same time; the light emission power is output to the second-line and fifth-line device groups at the same time; and the light emission power is output to the third-line and sixth-line device groups at the same time, does not occur, and in the LED driver 22, occurrence of this situation does not cause a malfunction. It is also conceivable that by using this, the LED driver 22 reduces the number of PWM circuits 22a.

Besides, when comparing the present embodiment with the second embodiment, it is conceivable that by increasing the number of PWM circuits 22a, the number of control channels corresponding to one PWM circuit 22a is reduced and it is possible to set longer light emission capable periods of each control channel. If it is assumed that the light emission capable periods of the respective control channels are the same, the ratio between the light emission capable period and the frame period for one control channel becomes theoretically equal to or lower than 1/S (S is the number of control channels corresponding to one PWM circuit 22a.).

The present embodiment corresponds to a case where S=2, accordingly, if the light emission capable periods of the respective control channels are the same, the ratio between the light emission capable period and the frame period for one control channel becomes equal to or lower than 50%. Besides, considering a duty ratio when the whole frame period is 100%, the duty ratio for the PWM control, which is able to be set for each control channel, becomes equal to or lower than 50%.

Meanwhile, considering likewise, the second embodiment corresponds to a case where S=N, the duty ratio for the PWM control, which is able to be set for each control channel, is equal to or lower than 1/N. Because of this, in the present embodiment, compared with the second embodiment (case where N is 3 or larger), it is easy to set a large duty ratio. As is clear from this example, it is desirable that the number of control channels corresponding to one PWM circuit 22a is suitably decided in accordance with the size of the duty ratio that is set (or expected to be set) for each control channel.

### 4. Others

As described above, the television broadcast receiver 1 according to each embodiment includes the LED driver 22 (driver apparatus) and the plurality of device groups each of which includes one or the plurality of light emitting devices (in the case of the first embodiment, for example, the group 1R, the group 1G and the group 1B; in the case of the third embodiment, for example, the group 1 and the group 4). Besides, the television broadcast receiver 1 uses the LED driver 22 to make the respective device groups emit light such that the light emission capable periods do not overlap one another, thereby displaying the image by using the obtained light as the backlight.

And, the LED driver 22 includes the PWM circuit 22a (power output circuit) in which the duty ratio is set for each device group, and which during the light emission capable period of the device group K, performs the PWM control at the duty ratio set for the device group K to adjust and output the light emission power. And, further, the LED driver 22 includes the switching mechanism 22b as well which in response to the arrival of the light emission capable period of the device group K, switches the output destination of the light emission power output from the PWM circuit 22a to the device group K.

Because of this, in the television broadcast receiver 1, it is possible to make the output destination of the light emission power output from the same PWM circuit 22a to each of the plurality of device groups without discouraging the light emission of the light emitting device. Because of this, in the television broadcast receiver 1, for example, compared with the apparatus which is provided with the PWM circuit for each device group, it becomes possible to use each PWM circuit more efficiently (reduce the period for the standby state) and reduce the number of PWM circuits.

Besides, in the television broadcast receiver 1 according to the first embodiment, the device groups are disposed to be different from one another in the light emission color, and the image is displayed by the field sequential system which uses the light emission capable period for each device group for each field. Besides, in the television broadcast receivers 1 according to the second and third embodiment, each device group is disposed for each cluster of the LEDs 23 (light emitting device) that are disposed to form a line in the horizontal direction (predetermined direction), each device group is made to emit light, whereby the LED 23 is made to function as the scanning backlight.

Besides, the LED driver 22, as a single one, is the apparatus which includes the plurality of control channels to which the LED 23 is connected and outputs the light emission power used for the light emission of the LED 23, further, receives the input of the information about the light emission capable period and duty ratio of each control channel.

Besides, the LED driver 22 includes the PWM circuit 22a in which the duty ratio is set for each device group, and which during the light emission capable period of the control channel Kch, performs the PWM control at the duty ratio set for the control channel Kch to adjust and output the light emission power. And, the LED driver 22 includes the switching mechanism 22b as well which in response to the arrival of the light emission capable period of the control channel Kch, switches the output destination of the light emission power output from the PWM circuit 22a to the LED 23 connected to the control channel Kch.

Because of this, in the LED driver 22, it is possible to make the output destination of the light emission power output from the same PWM circuit 22a correspond to a device group connected to each of the plurality of control channels without discouraging the light emission of the LED 23. Because of this, for example, compared with the apparatus which is provided with the PWM circuit for each control channel, it is possible to reduce the number of PWM circuits. Meanwhile, the LED driver 22 is suitable as a component for the television broadcast receiver 1 as described above, however, is not limited to this usage.

Besides, hereinbefore, the examples of the embodiments of the present invention are described, however, the present invention is not limited to the content. It is possible to make various modifications to the embodiments of the present invention as long as they do not depart from the spirit of the present invention. Part of the modifications of the embodiments are described for reference.

In the present embodiments, as an example of the image display apparatus, the television broadcast receiver (which is also a liquid crystal display apparatus) is described, and as an example of the light emitting device, the LED is described, however, other kinds may be used. Besides, as the control method for adjusting the light emission power, a control method other than the PWM control may be used. Besides, the duty ratio for the PWM control may be fixed at a predetermined value.

### INDUSTRIAL APPLICABILITY

The present invention is usable for various image display apparatuses.

### REFERENCE SIGNS LIST

1 television broadcast receiver (image display apparatus)
10 control portion
11 operation portion
12 broadcast reception portion
13 broadcast signal process portion
14 image signal process portion
15 liquid crystal panel unit
15a liquid crystal panel
15b panel driver
16 backlight unit
21 LED controller
22 LED driver (driver apparatus)
22a PWM circuit (power output circuit)
22b switch mechanism
23 LED (light emitting device)
24 LED mount board
31 PWM value register
32 counter
33 output terminal
34 comparator
35 switch mechanism

1. An image display apparatus comprising:
a driver apparatus; and
a total of N device groups of a first group to an N-th group (2≦N) each of which includes one or a plurality of light emitting devices,
the image display apparatus uses the driver apparatus to make each of the device groups emit light preventing light emission capable periods from overlapping one another and displays an image by using the obtained light as backlight; wherein
the driver apparatus includes:
a power output circuit that outputs light emission power used for the light emission of the light emitting device; and
a switch mechanism that switches, in accordance with arrival of the light emission capable period of a device group K (1≦K≦N), an output destination of the light emission power output from the power output circuit to the device group K.

2. The image display apparatus according to claim 1, wherein
the power output circuit performs PWM control at a set duty ratio to adjust the light emission power.

3. The image display apparatus according to claim 2, wherein
the power output circuit sets the duty ratio for each of the device groups, and performs the PWM control at the duty ratio set for the device group K during the light emission capable period of the device group K.

4. The image display apparatus according to claim 1, wherein
the device groups are disposed to be different from one another in light emission color; and
the image is displayed by using a field sequential system during the light emission capable period of each of the device groups in each field.

5. The image display apparatus according to claim 1, wherein
each of the device groups is disposed for each cluster of the light emitting devices that are disposed to form a line in a predetermined direction; and
each of the device groups emits light to make the light emitting device function as scanning backlight.

6. The image display apparatus according to claim 1, wherein
the light emitting device is an LED.

7. The image display apparatus according to claim 1, wherein
the image display apparatus is a liquid crystal display apparatus that includes a liquid crystal panel which has a plurality of pixels, and adjusts a transmittance degree of the backlight for each of the pixels to display the image.

8. A driver apparatus that comprises a total of N control channels of 1ch to Nch (2≦N) to which the light emitting device is connected and outputs the light emission power used for the light emission of the light emitting device, wherein
the driver apparatus receives input of information about a light emission capable period of each of the control channels, and comprises:
a power output circuit that outputs the light emission power; and
a switch mechanism that switches, in accordance with arrival of the light emission capable period of a control channel Kch (1≦K≦N), an output destination of the light emission power output from the power output circuit to the light emitting device connected to the control channel Kch.

9. The driver apparatus according to claim 8, wherein
the power output circuit performs PWM control at a set duty ratio to adjust the light emission power.

10. The driver apparatus according to claim 9, wherein
the power output circuit sets the duty ratio for each of the control channels, and performs the PWM control at the duty ratio set for the control channel Kch during the light emission capable period of the control channel Kch.

11. The driver apparatus according to claim 8, wherein
the driver apparatus is a driver apparatus that outputs the light emission power to an LED disposed as the light emitting device.

12. A backlight unit comprising:
a driver apparatus; and a light emitting device connected to each of the control channels according to claim 8, wherein
light emitted from the light emitting device is used as backlight for image display.

13. An image display apparatus that comprises the backlight unit according to claim 12, and uses the backlight emitted from the backlight unit to display an image.
